(19) United States
(12) Patent Application Publication
(10) Pub. No.: US 2025/0052217 A1
(43) Pub. Date: Feb. 13, 2025

(54) CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 18/774,536

(22) Filed: Jul. 16, 2024

(30) Foreign Application Priority Data
Aug. 7, 2023 (JP) 2023-128725

(51) Int. Cl. F02M 25/08; B01D 53/04

(52) U.S. Cl. CPC F02M 25/0854; B01D 53/0407; B01D 2253/34

(57) ABSTRACT

A canister configured to adsorb evaporated fuel generated in a fuel tank of a vehicle includes a plurality of lumpy adsorbents and an atmosphere port. The plurality of lumpy adsorbents are arranged to be aligned in a flow direction of the evaporated fuel in a flow path through which the evaporated fuel passes, and adsorb the evaporated fuel. The atmosphere port is provided at an end of the flow path, and is open to atmosphere. The plurality of lumpy adsorbents at least include a first lumpy adsorbent and a second lumpy adsorbent adjacent to each other. The first lumpy adsorbent includes at least one protrusion protruding from a surface of the first lumpy adsorbent facing the second lumpy adsorbent. The at least one protrusion forms a gap between the first lumpy adsorbent and the second lumpy adsorbent around the at least one protrusion.

### CROSS-REFERENCE TO RELATED APPLICATIONS

This application claims the benefit of Japanese Patent Application No. 2023-128725 filed on Aug. 7, 2023 with the Japan Patent Office, the entire disclosure of which is incorporated herein by reference.

### BACKGROUND

The present disclosure relates to a canister.

A vehicle such an automobile is equipped with a canister that inhibits evaporated fuel originating in a fuel tank from being discharged into the atmosphere. The canister is filled therein with an adsorbent such as activated carbon. The evaporated fuel originating in the fuel tank is introduced into the canister and then temporarily adsorbed by an adsorbent. The evaporated fuel adsorbed is desorbed from the adsorbent upon ignition of an internal combustion engine, etc., and then supplied to the internal combustion engine.

Japanese Patent No. 7244553 discloses an evaporated fuel treatment device. The evaporated fuel treatment device comprises a plurality of adsorption chambers. The plurality of adsorption chambers are provided along a flow path of evaporated fuel inside a canister. Each adsorption chamber includes therein an adsorption layer filled with an adsorbent.

### SUMMARY

In the evaporated fuel treatment device disclosed in Japanese Patent No. 7244553, the adsorption layer is filled with a lumpy adsorbent. The lumpy adsorbent is formed, for example, using fibrous activated carbon. The lumpy adsorbent has, for example, a circular cylindrical shape or a polygonal columnar shape. In this evaporated fuel treatment device, the evaporated fuel adsorbed on the lumpy adsorbent moves inside the lumpy adsorbent by intermolecular forces so as to reach an equilibrium state. Thus, the evaporated fuel adsorbed on the lumpy adsorbent on a fuel tank side of a flow path of the evaporated fuel traverses the lumpy adsorbent to move to the atmosphere side of the flow path, and is more easily discharged into the atmosphere.

In one aspect of the present disclosure, it is desirable that a discharge amount of evaporated fuel into the atmosphere is reduced.

One aspect of the present disclosure provides a canister configured to adsorb an evaporated fuel generated in a fuel tank of a vehicle. The canister comprises a plurality of lumpy adsorbents and an atmosphere port. The plurality of lumpy adsorbents are arranged to be aligned in a flow direction of the evaporated fuel in a flow path through which the evaporated fuel passes, and configured to adsorb the evaporated fuel. The atmosphere port is provided at an end of the flow path, and is open to atmosphere. The plurality of lumpy adsorbents at least include a first lumpy adsorbent and a second lumpy adsorbent adjacent to each other. The first lumpy adsorbent has at least one protrusion protruding from a surface of the first lumpy adsorbent facing the second lumpy adsorbent. The at least one protrusion forms a gap between the first lumpy adsorbent and the second lumpy adsorbent around the at least one protrusion.

According to the configuration as above, a gap is formed between the first adsorbent and the second adsorbent. Therefore, it is possible to inhibit the evaporated fuel from moving between the first adsorbent and the second adsorbent. Accordingly, the discharge amount of evaporated fuel into the atmosphere can be reduced.

In one aspect of the present disclosure, the canister may comprise a plurality of adsorption chambers configured to adsorb the evaporated fuel in the flow path. The plurality of adsorption chambers may be arranged to be aligned in the flow direction. The first lumpy adsorbent and the second lumpy adsorbent may be arranged in an adsorption chamber closest to the atmosphere port in the flow direction among the plurality of adsorption chambers.

According to the configuration as above, the evaporated fuel adsorbed on the first lumpy adsorbent and the second lumpy adsorbent is reduced by adsorption of the evaporated fuel in adsorption chambers other than the adsorption chamber where the first lumpy adsorbent and the second lumpy adsorbent are arranged. Therefore, it is possible to reduce the discharge amount of evaporated fuel into the atmosphere.

In one aspect of the present disclosure, the at least one protrusion may contact the second lumpy adsorbent.

According to the configuration as above, the first lumpy adsorbent and the second lumpy adsorbent can be inhibited from moving due to vibrations or the like. Thus, it is possible to improve stability of the first lumpy adsorbent and the second lumpy adsorbent.

In one aspect of the present disclosure, the at least one protrusion may have a shape in which a cross-sectional area of a first cross section is smaller than a cross-sectional area of a second cross section. The first cross section and the second cross section are cross sections perpendicular to a protruding direction of the at least one protrusion. The first cross section is located closer to the second lumpy adsorbent than the second cross section.

According to the configuration as above, an area where the first lumpy adsorbent and the second lumpy adsorbent are in contact becomes smaller. Thus, the evaporated fuel can be inhibited from moving between the first adsorbent and the second adsorbent. Accordingly, it is possible to reduce the discharge amount of evaporated fuel into the atmosphere.

In one aspect of the present disclosure, a surface area of a surface facing the atmosphere port, of the lumpy adsorbent closest to the atmosphere port in the flow direction among the plurality of lumpy adsorbents, may be smaller than a surface area of a surface of the lumpy adsorbent opposite to the surface facing the atmosphere port.

According to the configuration as above, the surface area facing the atmosphere port, of the surface of the lumpy adsorbent adjacent to the atmosphere port, is reduced. Thus, it is possible to reduce the discharge amount of evaporated fuel into the atmosphere.

### BRIEF DESCRIPTION OF THE DRAWINGS

Example embodiments of the present disclosure will be described hereinafter with reference to the accompanying drawings, in which:

FIG. 1 is a schematic cross-sectional view of a canister;

FIG. 2 is a perspective view of a lumpy adsorbent in the canister of a first embodiment;

FIG. 3 is a cross-sectional view of a plurality of lumpy adsorbents arranged in a flow path of evaporated fuel in the canister of the first embodiment;

FIG. 4 is a perspective view of a lumpy adsorbent in the canister of another embodiment;

FIG. 5 is a perspective view of a lumpy adsorbent in the canister of another embodiment;

FIG. 6A is a cross-sectional view of a plurality of lumpy adsorbents arranged so that protrusions face each other in the canister of another embodiment, and FIG. 6B a cross-sectional view of a plurality of lumpy adsorbents having protrusions of different shapes in the canister of another embodiment; and

FIG. 7A is a cross-sectional view of a plurality of lumpy adsorbents in the canister of another embodiment, in which a lumpy adsorbent interposed between two lumpy adsorbents has protrusions formed on both sides in a flow direction of evaporated fuel, and FIG. 7B is a cross-sectional view of a plurality of lumpy adsorbents including a lumpy adsorbent without protrusions in the canister of another embodiment.

### DETAILED DESCRIPTION OF EXEMPLARY EMBODIMENTS

Embodiments of the present disclosure are not limited to the following embodiments, and may take various forms within the technical scope of the present disclosure.

### 1. First Embodiment

### [1-1. Configuration]

### [1-1-1. Overall Configuration]

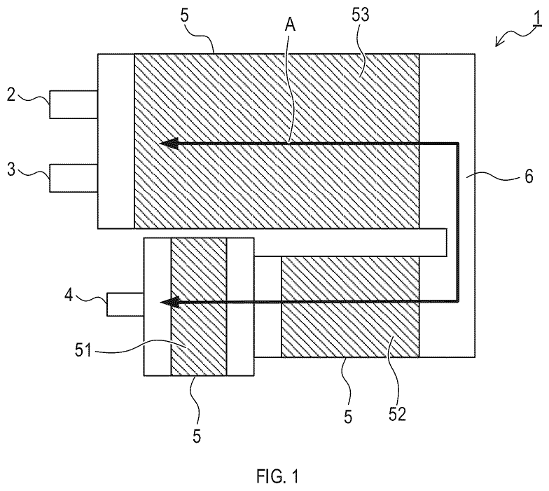

A canister 1 shown in FIG. 1 is mounted in a vehicle such as an automobile. The canister 1 is configured to adsorb evaporated fuel originating in a fuel tank of the vehicle to thereby inhibit the evaporated fuel from being discharged to the outside of the vehicle. The canister 1 is configured to take in the atmosphere from the outside of the vehicle to thereby desorb the evaporated fuel adsorbed. The canister 1 is configured to discharge the evaporated fuel desorbed to an internal combustion engine of the vehicle.

The canister 1 comprises a charge port 2, a purge port 3, an atmosphere port 4, and an adsorption unit 5 including a plurality of adsorption chambers. The canister 1 comprises therein a flow path through which a fluid such as evaporated fuel or atmosphere flows. Portions of the flow path function as the adsorption chambers. In the present embodiment, as an example, the flow path changes direction at a connecting passage 6. The flow path is approximately U-shaped as a whole. Hereinafter, a direction in which the fluid flows inside the canister 1 is referred to as a flow direction A.

The charge port 2 and the purge port 3 are both arranged at a first end of the canister 1 in the flow direction A. The atmosphere port 4 is provided at a second end of the canister 1 opposite to the first end in the flow direction A. Hereinafter, a side in the flow direction A where the charge port 2 and the purge port 3 are arranged is referred to as a vehicle side. A side in the flow direction A where the atmosphere port 4 is arranged is referred to as an atmosphere side.

The charge port 2 is connected to a fuel tank via piping. The charge port 2 is configured to introduce the evaporated fuel into the canister 1.

The purge port 3 is connected to an intake pipe of the internal combustion engine of the vehicle. The purge port 3 is configured to discharge the evaporated fuel out of the canister 1.

The atmosphere port 4 is connected to the outside of the vehicle to be open to the atmosphere. The atmosphere port 4 is configured to take the atmosphere into the canister 1. In addition, the atmosphere port 4 is configured to release gas that has been treated to remove the evaporated fuel to the atmosphere.

The plurality of adsorption chambers are provided inside the canister 1. In each of the plurality of adsorption chambers, an adsorbent that adsorbs the evaporated fuel is arranged. The canister 1 comprises a first adsorption chamber 51, a second adsorption chamber 52, and a third adsorption chamber 53, as the plurality of adsorption chambers. An example of the adsorbent is a porous material such as activated carbon, zeolite, and silica gel. Examples of activated carbon include granular activated carbon, an agglomerate of activated carbon formed into a honeycomb shape, and an agglomerate of activated carbon formed using fibrous activated carbon into a sheet shape, a rectangular parallelepiped shape, a circular cylindrical shape, a polygonal columnar shape, etc.

The plurality of adsorption chambers are connected in series along the flow direction A. The plurality of adsorption chambers are arranged in the order of the first adsorption chamber 51, the second adsorption chamber 52, and the third adsorption chamber 53 from the atmosphere port 4 side. The second adsorption chamber 52 and the third adsorption chamber 53 are connected via the connecting passage 6. In other words, in the flow direction A, the first adsorption chamber 51 and the second adsorption chamber 52 are provided closer to the atmosphere side than the connecting passage 6. In the flow direction A, the third adsorption chamber 53 is provided closer to the vehicle side than the connecting passage 6. In the present embodiment, a length of the plurality of adsorption chambers in the flow direction A is longer in the order of the third adsorption chamber 53, the second adsorption chamber 52, and the first adsorption chamber 51.

### [1-1-2. Configuration of Lumpy Adsorbent]

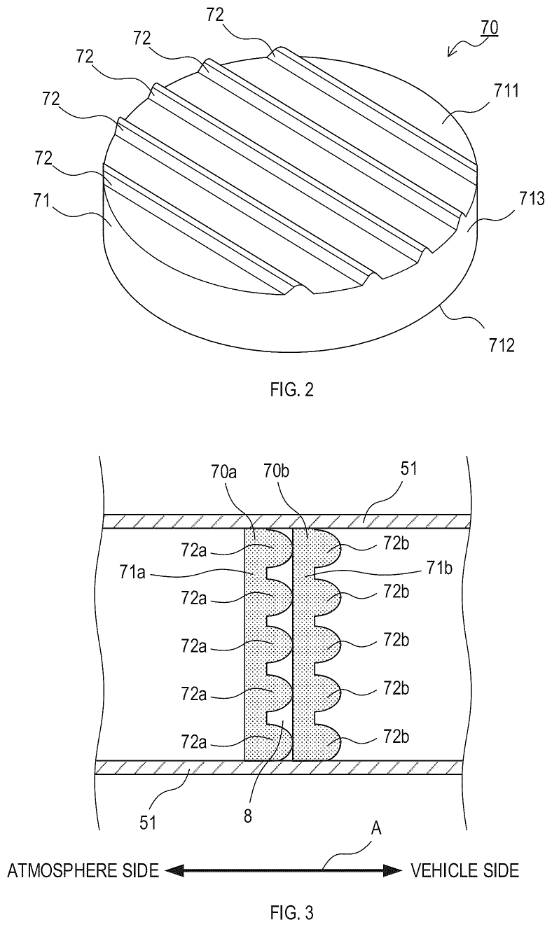

Inside the first adsorption chamber 51, a plurality of lumpy adsorbents 70 that are agglomerated adsorbents for adsorbing the evaporated fuel are arranged. As shown in FIG. 2, each of the lumpy adsorbents 70 comprises a main body 71 and at least one protrusion 72. The at least one protrusion 72 protrudes from a surface of the main body 71. An example of the lumpy adsorbent 70 is an agglomerate of activated carbon formed using fibrous activated carbon. According to an example shown in FIG. 2, each of the lumpy adsorbents 70 comprises a plurality of protrusions 72 as the at least one protrusion 72.

The main body 71 has a circular cylindrical outer shape to match the shape of the inner wall of the first adsorption chamber 51 that accommodates the lumpy adsorbents 70. The main body 71 has a first surface 711 and a second surface 712 facing each other, and a side surface 713. The protrusions 72 are portions protruding from the first surface 711 of the main body 71. The protrusions 72 are formed so that their cross-sectional area perpendicular to a protruding direction of the protrusions 72 decreases as a distance from the first surface 711 increases. In the present embodiment, as an example, five protrusions 72 are formed on the first surface 711 of each lumpy adsorbent 70. The five protrusions 72 have a shape of protruding ridges parallel to each other.

The protrusions 72 are formed by using a mold having recesses upon molding the lumpy adsorbent 70. According to another example, the protrusions 72 may be formed by partially cutting the lumpy adsorbent 70. The protrusions 72 may be formed by joining such as bonding to the main body 71 of the lumpy adsorbent 70.

### [1-1-3. Arrangement of Lumpy Adsorbent]

The canister 1 at least comprises a first lumpy adsorbent 70a and a second lumpy adsorbent 70b as the plurality of lumpy adsorbents 70. The shape and material of the first lumpy adsorbent 70a and the second lumpy adsorbent 70b are the same as those of the lumpy adsorbent 70 shown in FIG. 2. However, the shape and material of the first lumpy adsorbent 70a and the second lumpy adsorbent 70b are not limited thereto, and may differ from each other. The first lumpy adsorbent 70a includes a first main body 71a as the main body 71, and first protrusions 72a as the protrusions 72. The second lumpy adsorbent 70b includes a second main body 71b as the main body 71, and second protrusions 72b as the protrusions 72.

As shown in FIG. 3, the first lumpy adsorbent 70a and the second lumpy adsorbent 70b are aligned in the flow direction A inside the flow path so that both the first protrusions 72a and the second protrusions 72b face the vehicle side in the flow direction A. The first lumpy adsorbent 70a and the second lumpy adsorbent 70b are specifically arranged inside the first adsorption chamber 51. Surfaces (that is, first surfaces 711) of the first lumpy adsorbent 70a and the second lumpy adsorbent 70b on which the first protrusions 72a or the second protrusions 72b are formed are both approximately orthogonal to the flow direction A.

The first lumpy adsorbent 70a is arranged closer to the atmosphere side in the flow direction A than the second lumpy adsorbent 70b. The first lumpy adsorbent 70a is adjacent to the atmosphere port 4. The first lumpy adsorbent 70a and the second lumpy adsorbent 70b do not have the first protrusions 72a or the second protrusions 72b on their surfaces on the atmosphere side in the flow direction A. Those surfaces are approximately flat. Specifically, a surface area of a surface of the first lumpy adsorbent 70a facing the atmosphere port 4 is smaller than a surface area of a surface (in other words, a surface facing the second lumpy adsorbent 70b) of the first lumpy adsorbent 70a opposite to the surface facing the atmosphere port 4. Similarly, a surface area of a surface of the second lumpy adsorbent 70b facing the first lumpy adsorbent 70a is smaller than a surface area of a surface opposite to the surface facing the first lumpy adsorbent 70a. Differences in these surface areas in each of the lumpy adsorbents 70a, 70b are caused by presence or absence of the protrusions 72a, 72b.

The first protrusions 72a of the first lumpy adsorbent 70a are in contact with the surface of the second lumpy adsorbent 70b facing the first lumpy adsorbent 70a. The first protrusions 72a form gaps 8 between the first lumpy adsorbent 70a and the second lumpy adsorbent 70b around the first protrusions 72a. The first protrusions 72a are formed so that their cross-sectional area perpendicular to a protruding direction of that first protrusions 72a decreases as a distance to the second lumpy adsorbent 70b decreases.

The first lumpy adsorbent 70a and the second lumpy adsorbent 70b are fixed by being press-fitted into the first adsorption chamber 51. According to another example, the first lumpy adsorbent 70a and the second lumpy adsorbent 70b may be fixed by a fixing member provided inside the first adsorption chamber 51. In the present embodiment, a cross section of the first adsorption chamber 51 perpendicular to the flow direction A has a circular shape. Side surfaces of the first lumpy adsorbent 70a and the second lumpy adsorbent 70b are in contact with an inner peripheral surface of the first adsorption chamber 51 so as not to form gaps between the side surfaces and a surface of the first adsorption chamber 51 along the flow direction A.

### [1-2. Operations and Effects]

According to the embodiment detailed in the above, the following operations and effects can be achieved.

(1a) The first lumpy adsorbent 70a is arranged closer to the atmosphere side in the flow direction A than the second lumpy adsorbent 70b. The first protrusions 72a of the first lumpy adsorbent 70a are in contact with the surface of the second lumpy adsorbent 70b facing the first lumpy adsorbent 70a. The first protrusions 72a form gaps 8 between the first lumpy adsorbent 70a and the second lumpy adsorbent 70b around the first protrusions 72a.

According to the configuration as above, the evaporated fuel that flows into the first adsorption chamber 51 is firstly adsorbed by the second lumpy adsorbent 70b. The evaporated fuel adsorbed by the second lumpy adsorbent 70b moves to the first lumpy adsorbent 70a by intermolecular forces that act between the evaporated fuel and the first lumpy adsorbent 70a. At this time, the first lumpy adsorbent 70a contacts the second lumpy adsorbent 70b at the first protrusions 72a, not at a first surface of the first main body 71a of the first lumpy adsorbent 70a. Thus, an area of the contact portion is smaller than when the first surface of the first main body 71a of the first lumpy adsorbent 70a comes into surface contact with the second lumpy adsorbent 70b in the case that the first protrusions 72a are not formed on the first lumpy adsorbent 70a.

Moreover, the first protrusions 72a are formed so that their cross-sectional area (hereinafter, referred to as the cross-sectional area of the first protrusions 72a) perpendicular to the protruding direction of the first protrusions 72a decreases as a distance to the second lumpy adsorbent 70b decreases.

According to the configuration as above, an area of the portion where the first lumpy adsorbent 70a contacts the second lumpy adsorbent 70b is smaller than when the first protrusions 72a have a constant cross-sectional area. The area of the contact portion is smaller than when the first protrusions 72a are formed so that their cross-sectional area increases as a distance to the second lumpy adsorbent 70b decreases.

Thus, it is difficult for the intermolecular forces to act between the evaporated fuel adsorbed in the second lumpy adsorbent 70b and the first lumpy adsorbent 70a. As a result, the evaporated fuel adsorbed in the second lumpy adsorbent 70b is inhibited from moving to the first lumpy adsorbent 70a. Accordingly, it is possible to reduce a discharge amount of evaporated fuel discharged from the first lumpy adsorbent 70a into the atmosphere via the atmosphere port 4.

(1b) The first lumpy adsorbent 70a and the second lumpy adsorbent 70b are arranged inside the first adsorption chamber 51 provided closest to the atmosphere port 4 side among the first adsorption chamber 51, the second adsorption chamber 52, and the third adsorption chamber 53. The evaporated fuel taken from the charge port 2 into the canister 1 passes through the third adsorption chamber 53, the second adsorption chamber 52, and the first adsorption chamber 51 in this order. In the first adsorption chamber 51, the second adsorption chamber 52, and the third adsorption chamber 53, adsorbents that adsorb the evaporated fuel are arranged.

According to the configuration as above, the evaporated fuel taken from the charge port 2 into the canister 1 is partially adsorbed by the adsorbents arranged in the second adsorption chamber 52 and the third adsorption chamber 53. Thus, the evaporated fuel flowing into the first adsorption chamber 51 has lower concentration than the evaporated fuel flowing into the second adsorption chamber 52 or the third adsorption chamber 53. Accordingly, it is possible to further reduce the discharge amount of evaporated fuel discharged from the first lumpy adsorbent 70a arranged in the first adsorption chamber 51 to the atmosphere via the atmosphere port 4.

(1c) The surface areas of the surfaces of the first lumpy adsorbent 70a and the second lumpy adsorbent 70b on the atmosphere side in the flow direction A are smaller than the surface areas of the surfaces of the first lumpy adsorbent 70a and the second lumpy adsorbent 70b on the vehicle side in the flow direction A, respectively.

According to the configuration as above, it is possible to further reduce the discharge amount of evaporated fuel that are discharged from the first lumpy adsorbent 70a to the atmosphere via the atmosphere port 4.

(1d) The first protrusions 72a of the first lumpy adsorbent 70a are in contact with the surface of the second lumpy adsorbent 70b facing the first lumpy adsorbent 70a.

According to the configuration as above, displacements of the first lumpy adsorbent 70a and the second lumpy adsorbent 70b in the flow direction A due to vibrations, etc. can be regulated. Thus, stability and durability of the first protrusions 72a and the second protrusions 72b can be improved.

(1e) The plurality of first protrusions 72a are formed on the first lumpy adsorbent 70a. The plurality of first protrusions 72a are in contact with the surface of the second lumpy adsorbent 70b facing the first lumpy adsorbent 70a.

According to the configuration as above, impact on the first protrusions 72a due to vibrations, etc. is dispersed. Moreover, since there are multiple portions at which the first lumpy adsorbent 70a comes into contact with the second lumpy adsorbent 70b, a position of the first lumpy adsorbent 70a relative to the second lumpy adsorbent 70b becomes stable. Thus, stability and durability of the first protrusions 72a can be improved.

(1f) The side surfaces of the first lumpy adsorbent 70a and the second lumpy adsorbent 70b are in contact with the inner peripheral surface of the first adsorption chamber 51 so as not to form gaps between the side surfaces and the surface of the first adsorption chamber 51 along the flow direction A.

According to the configuration as above, the evaporated fuel flowing into the first adsorption chamber 51 passes through the first lumpy adsorbent 70a and the second lumpy adsorbent 70b. Thus, it is possible to further reduce the discharge amount of evaporated fuel discharged from the first adsorption chamber 51 into the atmosphere via the atmosphere port 4.

(1g) The first protrusions 72a of the first lumpy adsorbent 70a are in contact with the surface of the second lumpy adsorbent 70b facing the first lumpy adsorbent 70a. The gaps 8 are formed around the first protrusions 72a.

According to the configuration as above, without using an isolation member such as a filter, the gaps 8 can be formed between the first lumpy adsorbent 70a and the second lumpy adsorbent 70b.

(1h) The first lumpy adsorbent 70a and the second lumpy adsorbent 70b have the same shape. Thus, the first lumpy adsorbent 70a and the second lumpy adsorbent 70b can be formed by the same manufacturing method. Accordingly, manufacturing costs of the first lumpy adsorbent 70a and the second lumpy adsorbent 70b can be reduced.

### 2. Other Embodiments

Although an embodiment of the present disclosure has been described hereinabove, the present disclosure is not limited to the above-described embodiment and can take various forms.

(2a) In the above-described embodiment, five protrusions 72 of the lumpy adsorbent 70 are formed on the first surface 711 of the lumpy adsorbent 70. These protrusions 72 have a shape of protruding ridges parallel to each other. However, the shape and number of the protrusions 72 are not limited thereto.

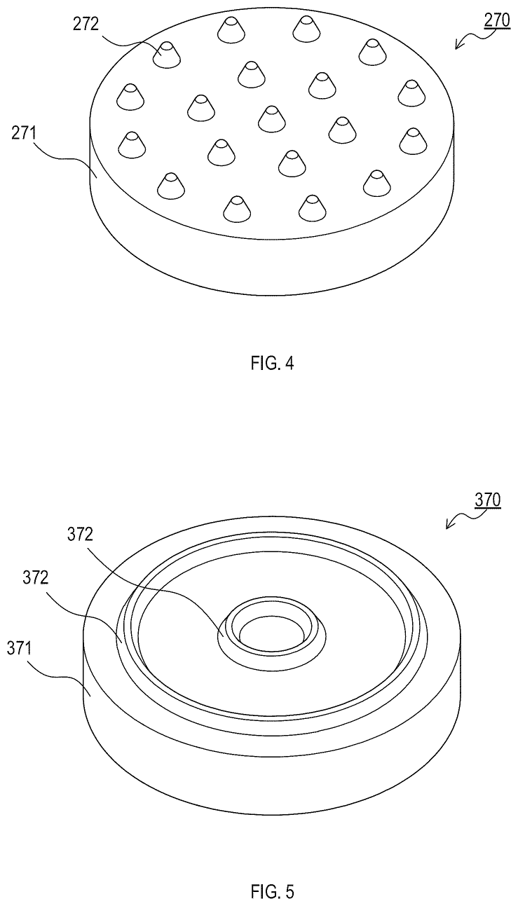

For example, the lumpy adsorbent 70 may be replaced with a lumpy adsorbent 270 shown in FIG. 4. The lumpy adsorbent 270 comprises a main body 271 and protrusions 272. The main body 271 has the same shape as the main body 71 of the lumpy adsorbent 70. The protrusions 272 have a cone shape protruding from a first surface of the main body 271. At least one protrusion 272 is formed on the first surface of the main body 271. For example, a plurality of protrusions 272 are formed.

Alternatively, the lumpy adsorbent 70 may be replaced with a lumpy adsorbent 370 shown in FIG. 5. The lumpy adsorbent 370 comprises a main body 371 and protrusions 372. The main body 371 has the same shape as the main body 71 of the lumpy adsorbent 70. The protrusions 372 protrude from a first surface of the main body 371, and extend in a ring shape around an axis of the main body 371 having a circular cylindrical shape. At least one protrusion 372 is formed on the first surface of the main body 371. For example, a plurality of protrusions 372 are formed.

(2b) In the above-described embodiment, the plurality of lumpy adsorbents 70 arranged inside the first adsorption chamber 51 are the first lumpy adsorbent 70a and the second lumpy adsorbent 70b. The first lumpy adsorbent 70a and the second lumpy adsorbent 70b have the same shape. The first lumpy adsorbent 70a and the second lumpy adsorbent 70b are aligned in the flow direction A inside the first adsorption chamber 51 so that both the first protrusions 72a and the second protrusions 72b face the vehicle side in the flow direction A. However, the shape, number, and orientation of the plurality of lumpy adsorbents 70 arranged inside the first adsorption chamber 51 are not limited thereto. The plurality of lumpy adsorbents 70 may have different shapes from each other. The number of the plurality of lumpy adsorbents 70 may be three or more. The protrusions 72 may face either the atmosphere side or the vehicle side in the flow direction A.

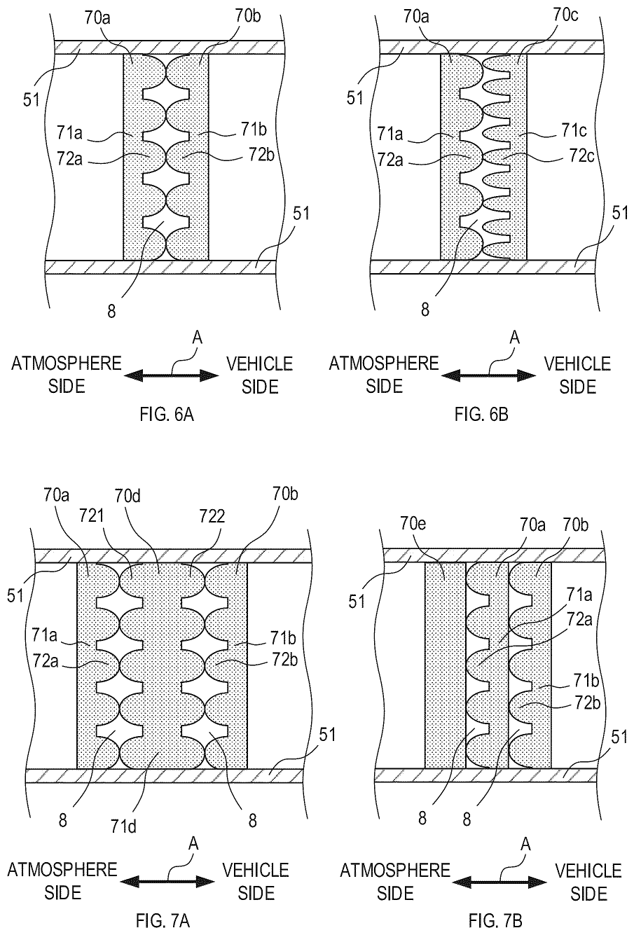

For example, as shown in FIG. 6A, the second lumpy adsorbent 70b may be arranged so that the second protrusions 72b face the atmosphere side in the flow direction A. In other words, the first lumpy adsorbent 70a and the second lumpy adsorbent 70b may be arranged so that the first protrusions 72a of the first lumpy adsorbent 70a and the second protrusions 72b of the second lumpy adsorbent 70b face each other. At this time, the first protrusions 72a may contact the second protrusions 72b.

Alternatively, as shown in FIG. 6B, the second lumpy adsorbent 70b may be replaced with a third lumpy adsorbent 70c. The third lumpy adsorbent 70c comprises, in place of the second protrusions 72b of the second lumpy adsorbent 70b, third protrusions 72c which differ from the first protrusions 72a of the first lumpy adsorbent 70a in at least one of number and shape. The third protrusions 72c are formed on a third main body 71c.

Alternatively, as shown in FIG. 7A, a fourth lumpy adsorbent 70d may be arranged between the first lumpy adsorbent 70a and the second lumpy adsorbent 70b, or in place of the second lumpy adsorbent 70b. The fourth lumpy adsorbent 70d may comprise fourth protrusions including at least one fourth protrusion 721 and at least one fourth protrusion 722. The fourth protrusion 721 is a portion protruding from a surface of a fourth main body 71d on the atmosphere side in the flow direction A. The fourth protrusion 722 is a portion protruding from a surface of the fourth main body 71d on the vehicle side in the flow direction A. The fourth protrusion 721 may contact the first protrusion 72a. The fourth protrusion 722 may contact the second protrusion 72b.

Alternatively, as shown in FIG. 7B, a fifth lumpy adsorbent 70e without the protrusions 72 may be arranged closer to the atmosphere side in the flow direction A than the first lumpy adsorbent 70a. A surface of the fifth lumpy adsorbent 70e on the atmosphere side in the flow direction A may be flat. At this time, the first lumpy adsorbent 70a and the second lumpy adsorbent 70b may be arranged so that both the first protrusions 72a and the second protrusions 72b face the atmosphere side in the flow direction A. The first protrusions 72a may contact a surface of the fifth lumpy adsorbent 70e facing the first lumpy adsorbent 70a. The second protrusions 72b may contact a surface of the first lumpy adsorbent 70a facing the second lumpy adsorbent 70b.

(2c) In the above-described embodiment, the lumpy adsorbent 70 has a circular cylindrical shape. However, the shape of the lumpy adsorbent 70 is not limited to the circular cylindrical shape. The shape of the lumpy adsorbent 70 may be, for example, any shape that fits on the inner peripheral surface of the first adsorption chamber 51. When a cross section of the first adsorption chamber 51 perpendicular to the flow direction A is polygonal, the lumpy adsorbent 70 may have a polygonal columnar shape that fits on the inner peripheral surface of the first adsorption chamber 51.

(2d) In the above-described embodiment, the protrusions 72 are formed so that their cross-sectional area perpendicular to the protruding direction of the protrusions 72 decreases toward the outside of the lumpy adsorbent 70. However, the cross-sectional area is not limited thereto.

For example, the first protrusions 72a may be formed so that, in a first cross section and a second cross section perpendicular to the protruding direction of the first protrusions 72a, a cross-sectional area of the first cross section positioned closer to the second lumpy adsorbent 70b than the second cross section is less than a cross-sectional area of the second cross section. The protrusions 72 may be formed so that their cross section parallel to the protruding direction of the protrusions 72 is stepped.

Alternatively, the cross section perpendicular to the protruding direction of the protrusions 72 may have a constant cross-sectional area. In other words, the protrusions 72 may have a circular cylindrical shape or a polygonal columnar shape.

(2e) Two or more functions performed by one element in the above-described embodiments may be achieved by two or more elements. One function performed by one element may be achieved by two or more elements. Two or more functions performed by two or more elements may be achieved by one element. One function performed by two or more elements may be achieved by one element. Furthermore, a part of a configuration in the above-described embodiments may be omitted. Still further, at least a part of the configuration in the above-described embodiments may be added to or replaced with another configuration of the above-described embodiments.

### Technical Ideas Disclosed in Present Disclosure

### [Clause 1]

A canister configured to adsorb evaporated fuel generated in a fuel tank of a vehicle, the canister comprising:
a plurality of lumpy adsorbents arranged to be aligned in a flow direction of the evaporated fuel in a flow path through which the evaporated fuel passes, and configured to adsorb the evaporated fuel; and
an atmosphere port provided at an end of the flow path, and is open to atmosphere,
the plurality of lumpy adsorbents at least including a first lumpy adsorbent and a second lumpy adsorbent adjacent to each other,
the first lumpy adsorbent having at least one protrusion protruding from a surface of the first lumpy adsorbent facing the second lumpy adsorbent, and
the at least one protrusion forming a gap between the first lumpy adsorbent and the second lumpy adsorbent around the at least one protrusion.

### [Clause 2]

The canister according to Clause 1, comprising
a plurality of adsorption chambers configured to adsorb the evaporated fuel in the flow path, wherein
the plurality of adsorption chambers are provided to be aligned in the flow direction,
the first lumpy adsorbent and the second lumpy adsorbent are arranged in an adsorption chamber closest to the atmosphere port in the flow direction among the plurality of adsorption chambers.

### [Clause 3]

The canister according to Clause 1 or 2, wherein
the at least one protrusion contacts the second lumpy adsorbent.

### [Clause 4]

The canister according to Clause 3, wherein
the at least one protrusion has a shape in which a cross-sectional area of a first cross section is smaller than a cross-sectional area of a second cross section,
the first cross section and the second cross section are cross sections perpendicular to a protruding direction of the at least one protrusion, and
the first cross section is located closer to the second lumpy adsorbent than the second cross section.

### [Clause 5]

The canister according to any one of Clauses 1 to 4, wherein
a surface area of a surface facing the atmosphere port, of a lumpy adsorbent closest to the atmosphere port in the flow direction among the plurality of lumpy adsorbents, is smaller than a surface area of a surface of the lumpy adsorbent opposite to the surface facing the atmosphere port.

What is claimed is:

1. A canister configured to adsorb evaporated fuel generated in a fuel tank of a vehicle, the canister comprising:
a plurality of lumpy adsorbents arranged to be aligned in a flow direction of the evaporated fuel in a flow path through which the evaporated fuel passes, and configured to adsorb the evaporated fuel; and
an atmosphere port provided at an end of the flow path, and is open to atmosphere,
the plurality of lumpy adsorbents at least including a first lumpy adsorbent and a second lumpy adsorbent adjacent to each other,
the first lumpy adsorbent having at least one protrusion protruding from a surface of the first lumpy adsorbent facing the second lumpy adsorbent, and
the at least one protrusion forming a gap between the first lumpy adsorbent and the second lumpy adsorbent around the at least one protrusion.

2. The canister according to claim 1, comprising:
a plurality of adsorption chambers configured to adsorb the evaporated fuel in the flow path, wherein
the plurality of adsorption chambers are provided to be aligned in the flow direction,
the first lumpy adsorbent and the second lumpy adsorbent are arranged in an adsorption chamber closest to the atmosphere port in the flow direction among the plurality of adsorption chambers.

3. The canister according to claim 1, wherein
the at least one protrusion contacts the second lumpy adsorbent.

4. The canister according to claim 3, wherein
the at least one protrusion has a shape in which a cross-sectional area of a first cross section is smaller than a cross-sectional area of a second cross section,
the first cross section and the second cross section are cross sections perpendicular to a protruding direction of the at least one protrusion, and
the first cross section is located closer to the second lumpy adsorbent than the second cross section.

5. The canister according to claim 1, wherein
a surface area of a surface facing the atmosphere port, of a lumpy adsorbent closest to the atmosphere port in the flow direction among the plurality of lumpy adsorbents, is smaller than a surface area of a surface of the lumpy adsorbent opposite to the surface facing the atmosphere port.
